(19) United States
(12) Patent Application Publication
(10) Pub. No.: US 2014/0007382 A1
(43) Pub. Date: Jan. 9, 2014

(54) METHOD AND APPARATUS FOR SECURING A BUTTON TO A FABRIC

(71) Applicant: CHRISTIAN MAKKI, Ashburn, VA (US)

(72) Inventor: CHRISTIAN MAKKI, Ashburn, VA (US)

(21) Appl. No.: 13/543,492

(22) Filed: Jul. 6, 2012

(51) Int. Cl. A44B 1/42; B23P 11/00; B29C 65/72

(52) U.S. Cl. 24/94; 156/92; 29/428

(57) ABSTRACT

A method and fastener assembly adapted to attach a button to a material via a fastener. The fastener includes a cross member having at least one pin with a first end connected to the cross member and a second end having a sharpened tip. The pins are adapted to slide into apertures in a button. The pin is then pushed through the material until the cross member and button seat against the front of the material. An extended length of the pin protruding through the back side of the material is bent over against the back side of the material. A protective shield having with an adhesive is bonded over the bent length of the pins to secure the fastener and button in place on the material.

### TECHNICAL FIELD

The subject disclosure relates to a button fastener assembly and particularly to a method for quickly and securely fastening a button to a material.

### BACKGROUND

The conventional method of attaching buttons to garments is via a needle and thread, and when such a button becomes detached, as is commonly the case, the conventional method of replacement is to sew a new button onto the garment in place of the missing button. In a first place, this is time consuming and requires a needle and thread and other equipment which may not be readily available. In a second instance, manipulating a piece of thread through an eye of a needle is tedious and painstakingly cumbersome during this replacement process.

It is desirable to provide an improved button or fastening means which would lend itself to almost instant replacement of a button without the requirement of needle and thread. Ideally, a replacement fastener could be attached without damaging the garment with which it is to be associated, and yet which would have the same appearance and would be as satisfactory as a button sewn on by a needle and thread. Although various solutions have been proposed, none available has effectively solved this problem with a portable, easy to apply fastener assembly.

### SUMMARY

The following presents a simplified summary of the subject disclosure in order to provide a basic understanding of some aspects thereof. This summary is not an extensive overview of the various embodiments of the subject disclosure. It is intended to neither identify key or critical elements of the subject disclosure, nor delineate any scope thereof. The purpose of the subject summary is to present some concepts in a simplified form as a prelude to the more detailed description that is presented hereinafter.

One or more embodiments of the subject disclosure provide for a method and fastener adapted to attach a button to a material. The fastener includes a cross member having at least one pin with a first end connected to the cross member and a second end having a sharpened tip. The pins are adapted to slide into apertures in a button. The pins are pushed through the material until the cross member and button seat securely against the front of the material. The excess remaining length of the pin protruding through the back side of the material is bent over against the back side of the material. A protective shield having a bonding mechanism is placed over the bent length of the pins. The protective shield covers the ends of the pins and secures the pins and button in a secure manner.

To the accomplishment of the foregoing and related ends, the subject disclosure, then, comprises the features hereinafter fully described. The following description and the annexed drawings set forth in detail certain illustrative aspects of one or more embodiments of the disclosure. However, these aspects are indicative of but a few of the various ways in which the principles of the subject disclosure may be employed. Other aspects, advantages and novel features of the subject disclosure will become apparent from the following detailed description of various example embodiments of the subject disclosure when considered in conjunction with the drawings.

### BRIEF DESCRIPTION OF DRAWINGS

FIG. 1 illustrates an exemplary exploded view of a fastener assembly in accordance with the subject disclosure.

FIGS. 2-3 depict the exemplary fastener being pushed through a piece of material.

FIG. 4 depicts sharpened edges of the pins being broken off.

FIG. 5 shows the remaining ends of the pins being folded over toward the material.

FIG. 6 illustrates the protective cover attached to the material and lying over the bent over ends of the pins.

FIG. 7 depicts a rear view of the attached button with the remaining ends of the pins in a folded over position.

FIG. 7A depicts a rear view of the attached button with the remaining ends of the pins in an outward folded over position.

FIG. 8 shows an exemplary configuration for the protective cover.

FIG. 9 illustrates the protective cover attached to the material, covering the bent over ends of the pins.

FIG. 10 depicts an exemplary garment having various fastener assembly's attached thereto.

FIG. 11 shows an exemplary kit including a plurality of fastener assembly's.

FIG. 12 illustrates the exemplary kit container.

### DETAILED DESCRIPTION

The subject disclosure is described with reference to the drawings, wherein like reference numerals are used to refer to like elements throughout. In the following description, for purposes of explanation, numerous specific details are set forth in order to provide a thorough understanding of the present disclosure. It may be evident, however, that the present disclosure may be practiced without these specific details.

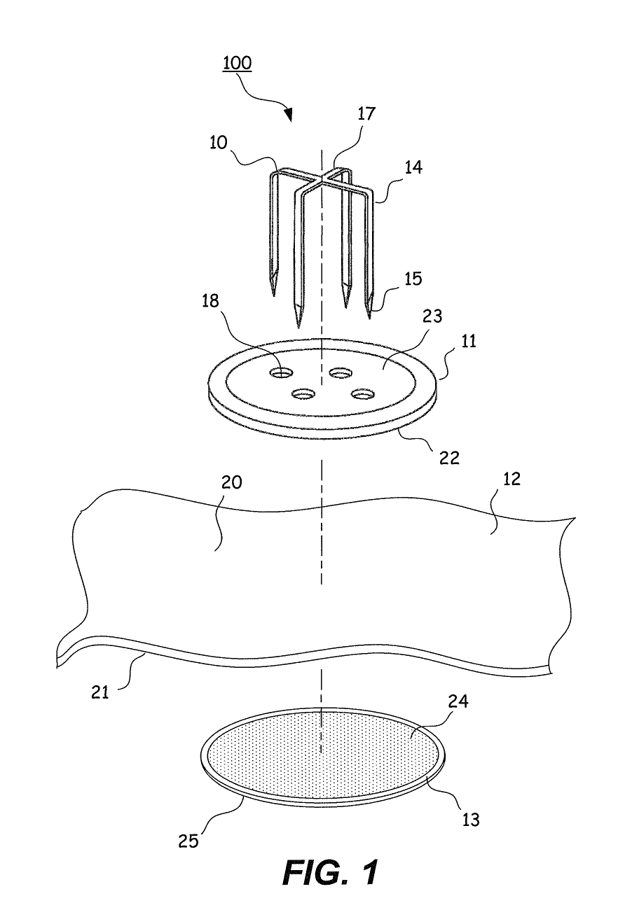

FIG. 1 illustrates an exemplary fastener assembly 100. The fastener assembly 100 includes a fastener 10 made of a cross member 17 with various pins 14 extending from the cross member 17. The various pins 14 are adapted to attach a button 11 to a piece of material 12 and/or other suitable material. The pins 14 are safely covered and secured by a protective shield 13 attached to the material 12 by a bonding mechanism.

The pins 14 extend away from the cross member 17. The cross member 17 shown includes four pin 14 legs. Although four pin 14 legs are shown, the cross member 17 may have more or less number of pins 14 extending therefrom. That is, a single pin 14 may be provided to extend from the cross member 17. Each of the pins 14 have sharpened ends 15 adapted to be pierced through a material 12 with moderate pressure applied to the cross member 17 portion of the fastener 10.

The various components of the fastener assembly 100 may be constructed of different types of rigid materials. Those materials may include but not limited to, a metal (including both post-transitional and transitional metalloids), an alloy, steel, brass, a strong and/or durable polymer, a composite and/or any suitable material. The material may be selected from a resilient material to prevent the brittle fracture of the fastener 10 and may be chosen sufficiently pliable enough to allow the pins 14 to be pressed through the material 12 and subsequently bent over to secure the pin 14 in place and to perform the various features and attributes described by the fastener assembly 100 of this subject disclosure.

The desired material characteristics that may be considered suitable for optimum use by the fastener assembly 100 may include, but not limited to: plasticity or restoring forces, rigidity, compression and tensile capacities, modulus of elasticity and deformation properties. A preferred material may be selected to exhibit the advantages associated with: malleability, ductility, slip, creep, fatigue limits and/or other suitable physical behaviors of the particular material used.

Various shapes and sizes may be selected for the cross members 17, the pins 14, the button 11, the protective shield 13 and the various other components of the subject disclosure. It is to be understood that various pin shapes and sizes may be selected to include, but not limited to a circular, an oval, a rectangular shape and/or any other preferred shape and/or size.

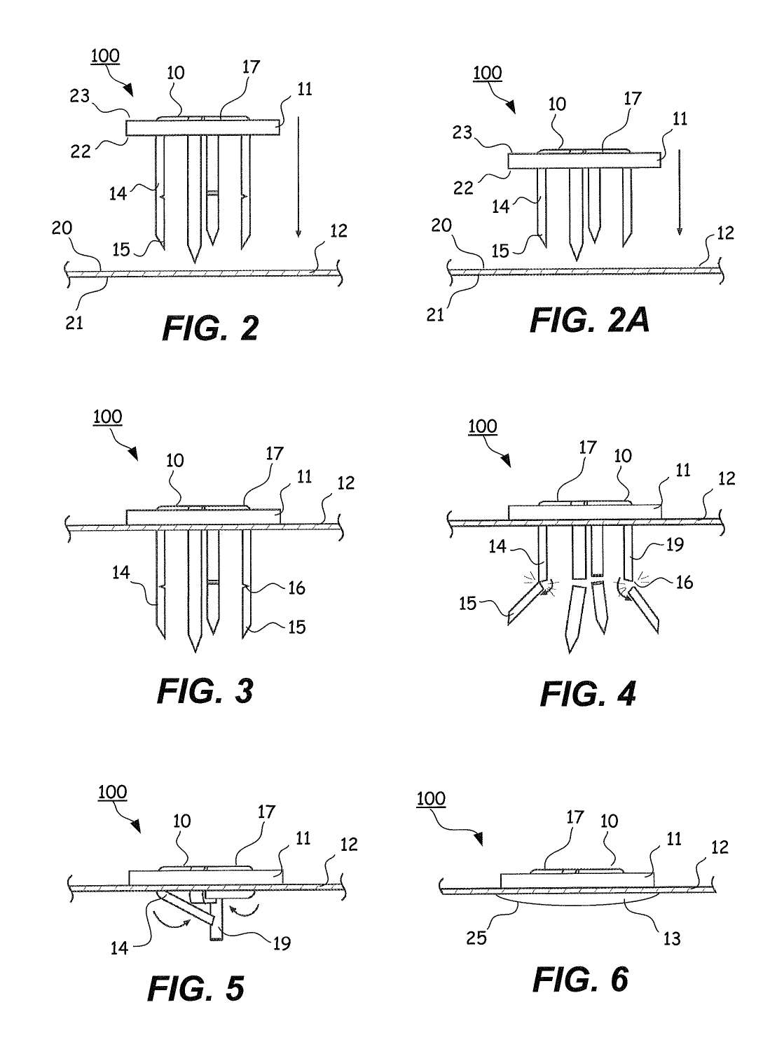

FIG. 2A illustrates the preferred exemplary embodiment for the fastener assembly 100. As shown, the sharpened ends 15 of the pins 14 would be pressed through the front side 20 of material 12 so that the cross member 17 lies flat against the front side 23 of button 11, and the back side 23 of button 11 lies against the front side 20 of material 12. The various sharpened ends 15 of the pins 14 in the fastener 10 are pierced through the front side 20 of material 12 until the cross members 17 and the button 11 are flattened out securely against the front side 20 of material 12.

As shown in FIG. 2, in an alternative construction, various notch indentations 16 may be provided in one or many of the pins 14. As also shown in FIG. 4, the notch indentations 16 may be provided along the shaft of the pin 14 that creates a thin cross section portion to weaken the pin 14 at a predetermined position along the shaft of the pin 14. Thus, the sharpened end 15 of the pin 14 can be broken and separated from the remainder of the pin 14 at the notch indentation 16 for safety purposes. That is, after the pins 14 have pierced the material 12, the sharpened end 15 may be broken off at the notch indentation 16.

The button 11 includes various apertures 18 through which the various pins 14 may be adapted to slide through. Equal number of pins 14 is complemented by equal number of apertures 18 to secure the button 11 to a material surface. Although shown as a conventional button 11, it is possible to use any type of button-like fastener, including or excluding various apertures.

Referring to FIGS. 4-5, after the sharpened ends 15 of the pins 14 have been pierced through the material 12, the sharpened ends 15 may be broken off. An excess remaining length 19 of the pin 14 protruding through the back side 21 of the material 12 may then be bent over against the back side 21 of the material 12 to secure the button 11 in place.

The protective shield 13 includes a bonding mechanism and/or material to secure the protective shield 13 against the back side 21 of the material 12. The bonding mechanism may be any suitable bonding media capable of securing the protective shield 13 to the back side 21 of the material 12. Various alternatives may include a hook and eye fastener, an adhesive or other suitable bonding mechanisms. In this example, an adhesive 24 is employed. In use, the protective shield 13 and the adhesive 24 may be placed over the bent over length 19 of the pins 14 and the back side 21 of the material 12 to secure the pins 14 from unraveling and dislodging the fastener assembly 100 from its secure position.

Although described as an adhesive, various types of a bonding agents and/or adhering materials may be employed, such as but not limited to, bonding, fusing, heat adhesive and/or any other type of fastening means suitable for securing the protective shield 13 over the bent over length of the pin 14 in a safe and secure manner.

FIGS. 2-6 illustrate an exemplary method for securing a button 11 to a material 12 employing the fastener assembly 100. In more detail, FIG. 2 shows the fastener 10 being aligned over the front side of the material 12 at a predetermined location to be pressed through the front side 20 of material 12. The preferred position may correspond to a position on a piece of material where the button-like fastener is to be attached for example, with a mating eyelet. The various legs of the pins 14 are aligned with the various apertures 18 in the button 11 and then pressed through the apertures 18 and the front side 20 of material 12.

Referring back to FIG. 2A, the fastener 10 does not include notched indentations 16 as shown in FIGS. 2-6. The various the sharpened ends 15 of the pins 14 are pressed through the front side 20 of material 12 until the cross members 17 and the button 11 are flattened out securely against the front side 20 of material 12. Similar to FIG. 5, the pins 14 are folded over so that the extended portion of the pins 14 protruding through the back side 21 of the material 12 are bent over to lie against the back side 21 of the material 12. As described in FIG. 6, the protective shield 13 is secured completely over the entire length of the unbroken folded over pins 14.

Referring back to FIG. 3, it depicts the fastener 10 pressed through the front side 20 of the material 12 so that the cross member 17 lies flat against the front side 23 of the button 11 and the back side 22 of the button 11 lies against the front side 20 of material 12 . The various sharpened ends 15 of the pins 14 in the fastener 10 have pierced through the front side 20 of the material 12 until the cross members 17 and the button 11 are flattened out securely against the front side 20 of the material 12.

FIG. 4 shows an alternative process in which the sharpened ends 15 of the pins 14 may be broken off at a position including the notched indentations 16. That is, the reduced thickness in the pin 14 legs defined by the notched indentations 16 cause the pins 14 to be weakened at that location so that the sharpened ends 15 may be easily broken off without affecting the remaining excess length 19 of the pins 14.

FIG. 5 depicts the remaining excess length 19 of the pins 14 being folded over after the sharpened ends 15 have been broken off. As shown, the extended portion of the pin 14 protruding through the back side 21 of the material 12 is bent over (as shown by the arrows) to lie against the back side 21 of the material 12. The folded bend in the pins 14 create the anchor necessary to secure the cross member 17 and the button 11 to the material 12.

FIG. 6 illustrates the secure placement of a protective shield 13 over the unbroken length of the legs of the pins 14 as shown in FIG. 2A. The same applies to the excess remaining length 19 of the pins 14 shown in FIG. 5. Although shown as a domed protective shield 13 cover, any size or shape may be constructed according to the subject disclosure, such as but not limited to, a cylindrical, a spherical shape and/or any other suitable shape for the protective shield 13.

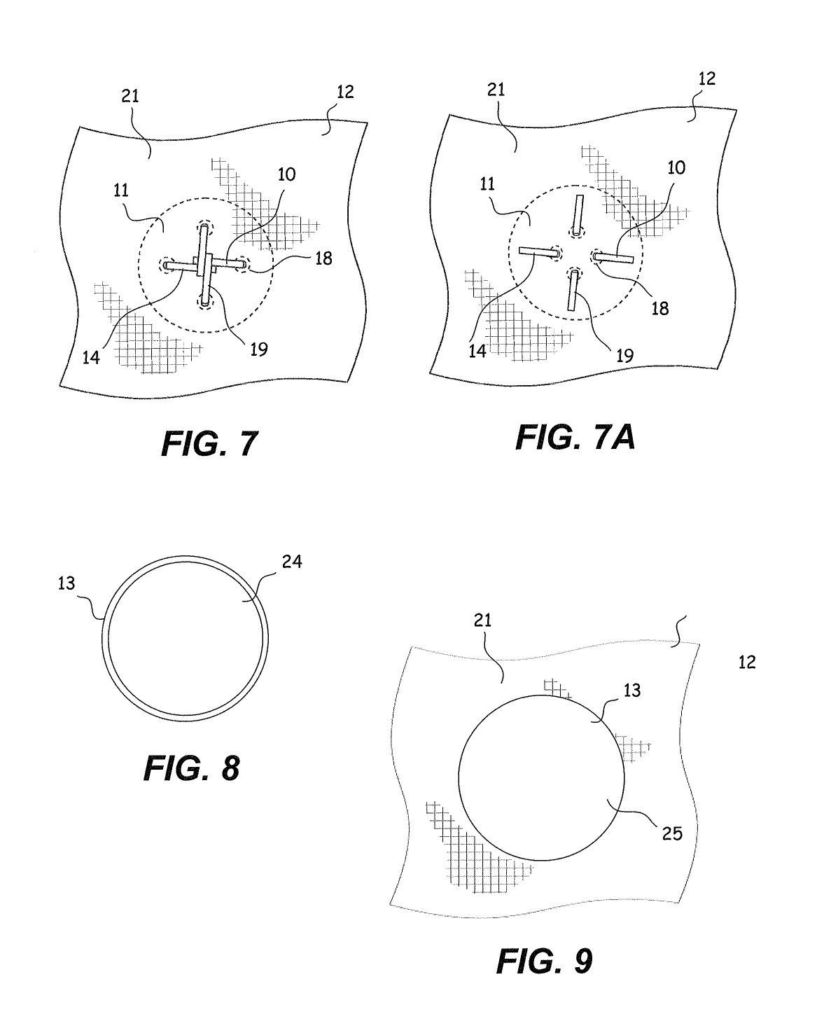

FIG. 7 illustrates an exemplary back side 21 view of the material 12 having the fastener 10 pushed through and the pins 14 folded over. The pins 14 are folded over in an overlapping pattern. This exemplary pattern may be practiced using any of the fastener assembly's 100 of this subject disclosure. That is, the legs of the pins 14 shown in FIG. 2A, and/or the excess remaining length 19 of the pins 14 shown in FIG. 5 may be securely fastened against the back side 21 of material 12. Alternatively, the pins 14 may be folded over in an outward configuration, such as where the cross members 17 of the fastener assembly is narrow in construction as shown in FIG. 7A.

FIG. 8 shows an adhesive 24 disposed on a front side 26 of the protective shield 13. When the protective shield 13 is aligned over the unbroken ends (as shown in FIG. 2A) or broken excess remaining length 19 (as shown in FIG. 5), the pins 14 may be completely covered by the placement of the protective shield 13. The back side 25 of protective shield 13 surface should preferably be smooth so that other surfaces (such as a shirt, undergarments, a person's skin or the like) coming into contact with the back side 25 of protective shield 13 are not harmed by a dangerously rough surface.

FIG. 9 shows the placement of the protective shield 13 over the unbroken ends (as shown in FIG. 2A) or broken excess remaining length 19 (as shown in FIG. 5), the pins 14. As shown, the protective shield 13 completely covers the ends of the pins 14 so that there is limited contact with the pins 14. As mentioned previously, the adhesive 24 may be any type of suitable bonding material capable of securely fastening the protective shield 13 over the ends of the pins 14, and the back side 21 of the material 12 according to the subject disclosure.

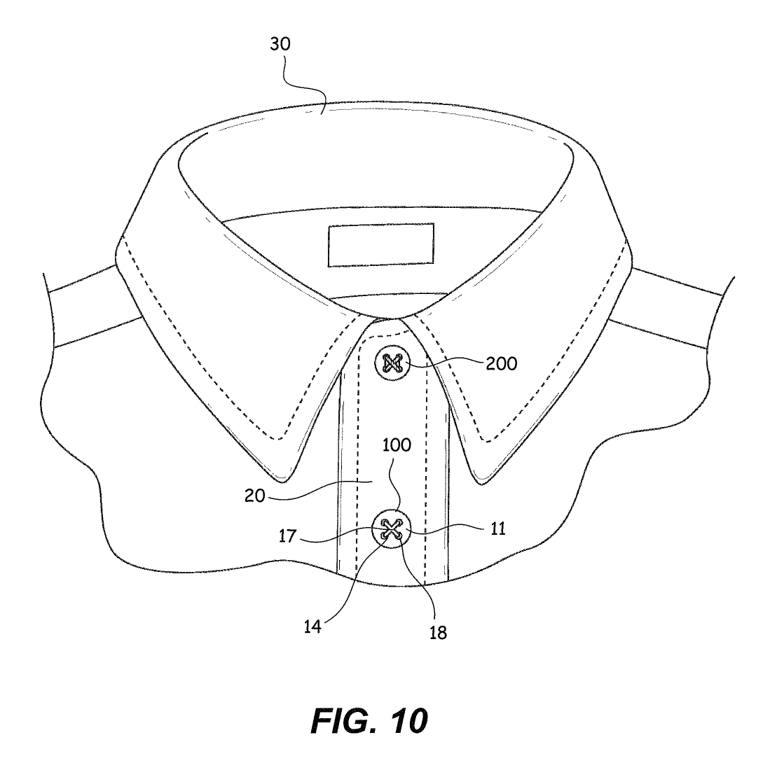

In use, FIG. 10 depicts an exemplary garment 30 including the use of a fastener assembly 100 according to this subject disclosure. By comparison, a conventional button 200 located adjacent to the fastener assembly 100 is nearly unnoticeable. The attached fastener assembly 100 is shown disposed through an eyelet in a secure manner.

Although the garment 30 shown is a dress shirt, it is to be understood that the fastener assembly 100 is versatile and may be placed on various different types of garments 30. Some of which may encompass various items such as: trousers, undergarments, shoes, bags, belts, or the like. The fastener assembly 100 may be used in combination with any suitable material. Likewise, although a button 11 is shown in use, it is also understood that the item being attached may be any number of various fastening items.

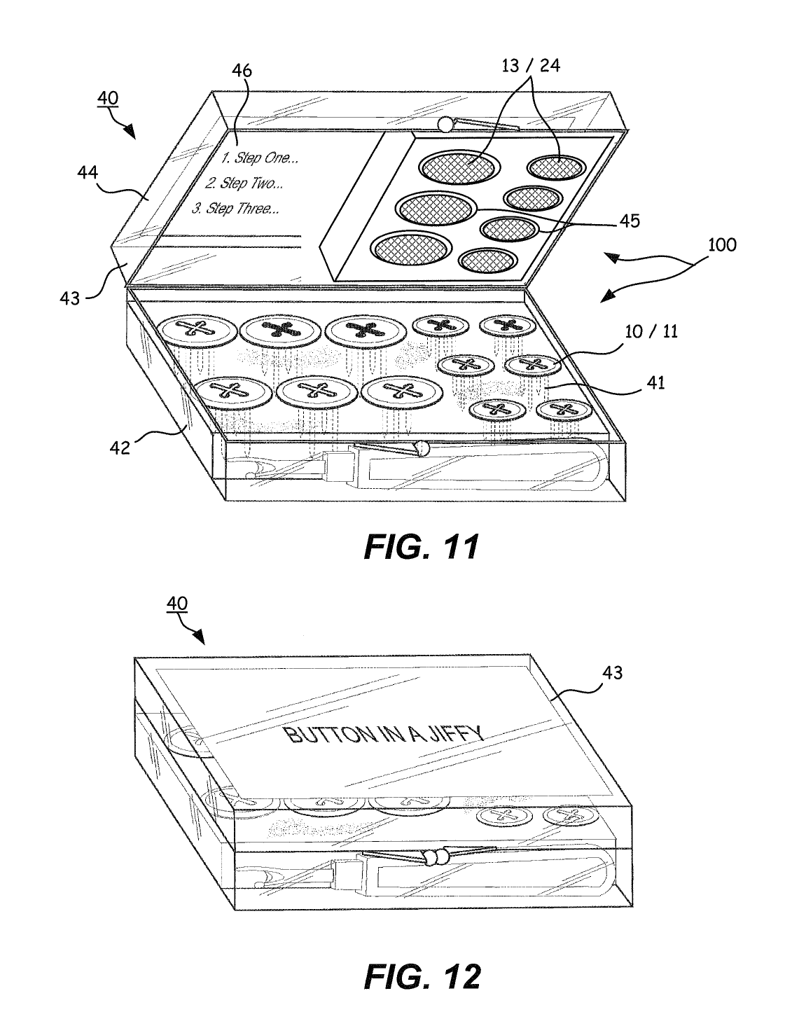

FIG. 11 shows an exemplary self-contained kit 40 including a plurality of fastener assembly's 100. The exemplary kit 40 may be embodied as a compartment or receptacle 43 comprised of a container 42 with a pivoting lid 44. As shown, the container 42 or lid 44 compartment may include a first set of pockets 41 adapted to receive various fasteners 10 and associated buttons 11. Likewise, the container 42 or lid 44 compartment may include a second set of pockets 45 adapted to receive the various protective shields 13. Other conventional items may be provided with the kit 40. Furthermore, the kit 40 may include a set of instructions 46 provided to inform a user of an exemplary method for securing the fastener assembly's 100 to a piece of material 12. FIG. 12 shows the receptacle 43 secured closed as a self-contained kit.

As employed in this specification and annexed drawings, the term “or” is intended to mean an inclusive “or” rather than an exclusive “or.” Moreover, articles “a” and “an” as used in the subject specification and annexed drawings should generally be construed to mean “one or more” unless specified otherwise or clear from context to be directed to a singular form.

What has been described above includes examples of a fastener assembly and method of installation that provide advantages of the subject disclosure. It is, of course, not possible to describe every conceivable combination of components or methodologies for purposes of describing the subject disclosure, but one of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

1. A fastener assembly adapted to attach a button to a material, comprising:
a fastener, comprising:
a cross member; and
at least one pin having a first end connected to the cross member and a second end having a sharpened tip adapted to pierce the material;
a button including at least one aperture adapted to receive the at least one pin, where in use, the cross member is adapted to captivate the button on to the material, and a length of the at least one pin protruding through the material is bent over against the back side of the material; and
a protective shield covers the bent length of the pin securing the fastener assembly.

2. The fastener assembly recited in claim 1, wherein an outer perimeter of the protective shield completely covers the bent length of the pin.

3. The fastener assembly recited in claim 1, wherein the protective shield is securely bonded over the bent length of the pin by an adhesive.

4. The fastener assembly recited in claim 1, wherein the fastener includes more than one pin.

5. The fastener assembly recited in claim 1, wherein the at least one pin has a notched indentation in the pin between the cross member and the sharpened tip provided to break away the pin.

6. The fastener assembly recited in claim 5, where in use, the sharpened tip is broken off, and an excess remaining length of the pin protruding through the back side of the material is bent over against the back side of the material.

7. A fastener assembly adapted to attach a button to a material, comprising:
a fastener, comprising:
a cross member; and
pins having a first end connected to the cross member and a second end having a sharpened tip adapted to pierce the material; and
a button including apertures adapted to receive the pins,
where in use the cross member is adapted to captivate the button on to the material, and a length of the pins protruding through the back side of the material is bent over against the back side of the material; and
a protective shield covers the bent length of the pins securing the fastener assembly.

8. The fastener assembly recited in claim 7, wherein the protective shield is securely bonded over the bent length of the pins by an adhesive.

9. The fastener assembly recited in claim 7, wherein the pins include a notched indentation disposed between the cross member and the sharpened tip provided to break away the pin.

10. The fastener assembly recited in claim 9, where in use, the sharpened tip is broken off, and an excess remaining length of the pins protruding through a back side of the material is bent over against the back side of the material.

11. The fastener assembly recited in claim 10, wherein the protective shield completely covers the bent excess remaining length of the pins securing the fastener assembly.

12. A method for attaching a button to a material, comprising:
sliding at least a pair of pins, having a first end connected to a cross member and a second end having a pair of sharpened tips, into a pair of aligned apertures in a button;
pushing the sharpened tips through the material until the button is secured between and seated adjacent to the cross member and the material; and
bending a length of the pins protruding through the material over against the back side of the material to secure the button in place; and
securing a protective shield over to cover the bent length of the pins.

13. The method recited in claim 12, wherein after the sharpened tips are pushed through the material, the method further comprises:
breaking off the sharpened tips of the pins at a notched indentation.

14. The method recited in claim 13, wherein after the sharpened tips of the pins are broken off, the method further comprises:
bending an excess remaining length of the pins protruding through the back side of the material over against the back side of the material to secure the button in place.

15. The method recited in claim 14, wherein after the excess remaining length of the pins are bent, the securing step comprises:
securing a protective shield over the excess remaining length of the pins.

16. The method recited in claim 12, wherein the protective shield is securely bonded over the bent length of the pins by an adhesive.

17. The method recited in claim 16, wherein the adhesive is activated to bond by a heat source.

18. (canceled)
